(19) United States
(12) Patent Application Publication
(10) Pub. No.: US 2026/0106273 A1
(43) Pub. Date: Apr. 16, 2026

(54) INSULATION CASE STRUCTURE FOR BATTERY

(71) Applicant: Ningbo Zhenyu Auto Parts Co., Ltd., Ningbo City (CN)

(72) Inventors: Yuan Liang, Ningbo City (CN); Qidi Dai, Ningbo City (CN); Jiben Tan, Ningbo City (CN); Wei Xie, Ningbo City (CN); Liang'en Wu, Ningbo City (CN)

(21) Appl. No.: 19/422,029

(22) Filed: Dec. 16, 2025

(30) Foreign Application Priority Data
Jun. 30, 2025 (CN) 202510891795.8

(51) Int. Cl. H01M 50/124; H01M 50/103; H01M 50/121; H01M 50/169; H01M 50/586

(52) U.S. Cl. CPC H01M 50/1243; H01M 50/103; H01M 50/169; H01M 50/586; H01M 50/121

(57) ABSTRACT

An insulation case structure for a battery. The case structure includes an outer shell and an inner liner shell. A first opening is formed in one side of the outer shell. The inner liner shell is embedded into the outer shell through the first opening. A second opening that is arranged in the same direction as the first opening is formed in one end of the inner liner shell. A connection ring is arranged in a surrounding manner between a periphery of the inner liner shell that is located at the second opening and an inner wall of the outer shell. The connection ring and a peripheral wall of the inner liner shell are fixedly connected to each other by welding, and the connection ring and the inner wall of the outer shell are fixedly connected to each other by welding.

### TECHNICAL FIELD

The present disclosure relates to the technical field of lithium batteries, and in particular, to an insulation case structure for a battery.

### BACKGROUND

A lithium battery usually includes a case and a battery assembly located inside the case. Insulation is required between the battery assembly and the case. Therefore, after the case is manufactured, a layer of insulation material is sprayed onto an inner wall of the case to meet an insulation requirement. Alternatively, after the battery assembly is manufactured, insulation treatment is performed on the battery assembly, such as wrapping around the battery assembly or performing injection molding on the battery assembly, to isolate the battery assembly from the case. Although this achieves an insulation effect, there are issues of high manufacturing costs, low production capacity, and low process reliability.

### SUMMARY

The present disclosure aims to provide an insulation case structure for a battery to solve the shortcomings of the above art.

The present disclosure provides an insulation case structure for the battery, including an outer shell, an inner liner shell made of an insulation material, and a connection ring that is arranged in a surrounding manner. An outer shell cavity is provided inside the outer shell, and a first opening is formed in one side of the outer shell cavity. The inner liner shell passes through the first opening and is at least partially embedded in the outer shell cavity of the outer shell. A second opening corresponding to the first opening is formed in the inner liner shell. The connection ring is arranged between the second opening and the outer shell in a surrounding manner, and is butted between an outer wall of the second opening and an inner wall of the first opening. The connection ring and a peripheral wall of the inner liner shell are fixed connected to each other. The connection ring and an inner wall of the outer shell are fixedly connected to each other.

Preferably, the outer shell is a box that is formed by enclosing a first side plate, a second side plate, a third side plate, a fourth side plate, and a bottom plate and has a cubic shape and an opening. The first side plate is opposite to the third side plate, and the second side plate is opposite to the fourth side plate. The bottom plate is opposite to the first opening. The opening is formed as the first opening.

In some preferred embodiments, the first side plate, the second side plate, and the third side plate are formed by bending a plate body end to end; and the fourth side plate and the bottom plate are fixedly connected to each other by welding, or the fourth side plate and the bottom plate are integrally arranged.

In some other preferred embodiments, the first side plate, the second side plate, the third side plate, and the fourth side plate are of a box structure that is formed by bending and connecting a plate body end to end and has openings in two ends; a joint line is located on a narrow-surface side plate and is connected by welding; the first opening and a third opening are respectively formed in the openings in the two ends of the outer shell; and the bottom plate is welded at the third opening.

Preferably, grooves are formed in an inner wall of the first side plate, an inner wall of the second side plate, an inner wall of the third side plate, and an inner wall of the fourth side plate to form a constant-temperature channel between the outer shell and the inner liner shell, to fill a heating source or a cooling source into the constant-temperature channel.

Preferably, a cross section of the connection ring is square; one side surface of the connection ring abuts against and is welded with the inner liner shell; and another opposite side surface of the connection ring abuts against and is welded with a side inner wall of the outer shell.

Further, a step surface is arranged on the inner wall of the outer shell; a bottom surface and a side surface, which faces the side inner wall of the outer shell, of the connection ring are snapped into the step surface; the second opening of the inner liner shell is outwards bent to form a bent portion, or a peripheral wall of the inner liner shell that is close to the second opening circumferentially protrudes out to form the bent portion; and a top surface and a side surface, which faces the peripheral wall of the inner liner shell, of the connection ring are snapped into the bent portion.

Preferably, the inner liner shell is made of the insulation material, and the connection ring and the outer shell are made of the same metal material.

Technical effects of the present disclosure are that the outer shell has the first opening, and the inner liner shell is embedded inside the outer shell from the first opening. The inner liner shell is provided with the second opening on the same side as the first opening. The inner liner shell is made of the insulation material, thereby forming an insulation cavity. The connection ring is arranged between the peripheral wall of the inner liner shell that is located at the second opening and the inner wall of the outer shell. The connection ring is connected to the inner liner shell and the outer shell respectively by welding, so that the inner liner shell and the outer shell are fixedly connected together. Meanwhile, both the outer shell and the connection ring are made of the metal materials, such as aluminum, and the inner liner shell is made of the insulation material, such as plastic. Welding the outer shell and the connection ring means welding the same kind of materials and welding the connection ring and the inner liner shell means welding different kinds of materials, so that welding fixation manners, i.e. laser welding and penetration welding, are respectively used. By using different welding manners, the connection is stable and firm, and the insulation life of the inner liner shell is longer. The opening of the inner liner shell is bent to form the bent portion, and the bent portion is snapped into the connection ring, thus improving the reliability of welding between the connection ring and the inner liner shell. This prevents the inner liner shell from moving after welded parts are separated, thus ensuring the stability of the inner liner shell. Meanwhile, an end cover is added at the first opening. The grooves are formed in the inner side wall of the outer shell. After the inner liner shell is embedded, the peripheral wall of the inner liner shell is enclosed with the grooves to form the constant-temperature channel. The constant-temperature channel is filled with a heating source or a cooling source, so that an entire case can be in a heating, cooling, or constant-temperature state.

### BRIEF DESCRIPTION OF THE DRAWINGS

FIG. 1 is an appearance diagram of an entire structure in the present disclosure;

FIG. 2 is a structural diagram of a first embodiment;

FIG. 3 is a structural diagram of a second embodiment;

FIG. 4 is a structural diagram of a third embodiment;

FIG. 5 is a first structural diagram of an inner wall of an inner liner shell having a step surface;

FIG. 6 is a second structural diagram of an inner wall of an inner liner shell having a step surface;

FIG. 7 is a structural diagram of an inner wall of an inner liner shell being a plane;

FIG. 8 is a structural diagram of an inner liner shell having a bent portion;

FIG. 9 is a structural diagram of a constant-temperature channel;

FIG. 10 is a structural diagram of positioning of an inner liner shell and a connection ring when a fixture is used; and

FIG. 11 is a schematic structural diagram of a junction line between a connection ring and an inner wall of an outer shell.

In the drawings: 1: outer shell; 11: first opening; 12: first side plate; 13: second side plate; 14: third side plate; 15: fourth side plate; 16: bottom plate; 17: third opening; 18: fourth opening; 19: step surface; 110: groove; 111: joint line; 112: constant-temperature channel; 2: inner liner shell; 21: second opening; 22: bent portion; 3: connection ring; 31: welding operation surface; 32: spot-welding trajectory; 33: junction; and 4: fixture.

### DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all the embodiments. Based on the embodiments of the present disclosure, all other embodiments obtained by a person of ordinary skill in the art fall within the protection scope of the present disclosure.

### First embodiment

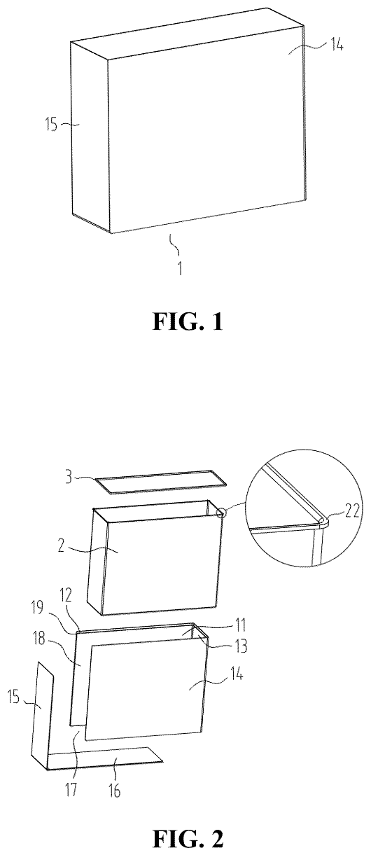

An insulation case structure for a battery includes an outer shell 1 and an inner liner shell 2. As shown in FIG. 1 to FIG. 3, the outer shell 1 is of a box structure. In this embodiment, the outer shell 1 has five side walls, and a first opening 11 is formed in the outer shell 1, so that the outer shell 1 forms a box structure with an opening. The inner liner shell 2 passes through the first opening 11 and is embedded inside the outer shell 1. The inner liner shell 2 is also of a box structure, so that it is convenient to place a battery cell assembly inside the inner liner shell 2. A second opening 21 that is arranged in the same direction as the first opening 11 is formed in one end of the inner liner shell 2. A connection ring 3 is arranged in a surrounding manner between a periphery of the inner liner shell 2 that is located at the second opening 21 and an inner wall of the outer shell 1. In this embodiment, the connection ring 3 is similar to a sealing ring and is of a strip-shaped structure. The connection ring 3 is sleeved on a peripheral wall of the inner liner shell 2. The connection ring 3 abuts against the peripheral wall of the inner liner shell 2, which facilitates fixed connection between the connection ring 3 and the peripheral wall of the inner liner shell 2 by welding. After the inner liner shell 2 and the connection ring 3 are fixed to each other, the inner liner shell 2 and the connection ring 3 are embedded together into the outer shell 1, and the connection ring 3 also abuts against the inner wall of the outer shell 1 at this time. Then, the connection ring 3 and the inner wall of the outer shell 1 are fixedly connected to each other by welding. The first side plate 12 is opposite to the third side plate 14. The second side plate 13 is opposite to the fourth side plate 15. The bottom plate 16 is opposite to the first opening 11.

Further, the outer shell 1 is made of a metal material, such as aluminum, and the inner liner shell 2 is made of an insulation material, such as a plastic material, which can be Polypropylene (PP), Polyethylene Terephthalate (PET), or the like. The connection ring 3 is also made of a metal material, such as aluminum, so that welding the connection ring 3 and the outer shell 1 means welding the same kind of materials, and welding the connection ring 3 and the inner liner shell 2 means welding different kinds of materials, which makes welding more convenient and reduces the defect rate. The welding of different kinds of materials is usually laser welding, forming welding fixation.

Further, a cross section of the connection ring 3 is square. One side surface of the connection ring 3 abuts against and is welded with the inner liner shell 2. Another opposite side surface of the connection ring 3 abuts against and is welded with the inner wall of the outer shell 1, so that an area of a welded surface is maximum, which improves the welding firmness.

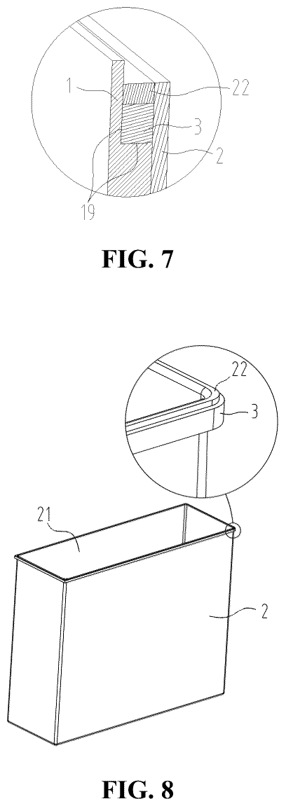

Further, the inner wall of the outer shell 1 can be a plane or can be provided with a step surface 19, as shown in FIG. 6. A bottom surface and a side surface, which faces the inner wall of the outer shell 1, of the connection ring 3 are respectively snapped into the step surface 19 to limit the connection ring 3. Then, the side surface of the connection ring 3 that faces the inner wall of the outer shell 1 and the inner wall of the outer shell 1 are welded together, as shown in FIG. 6 and FIG. 7.

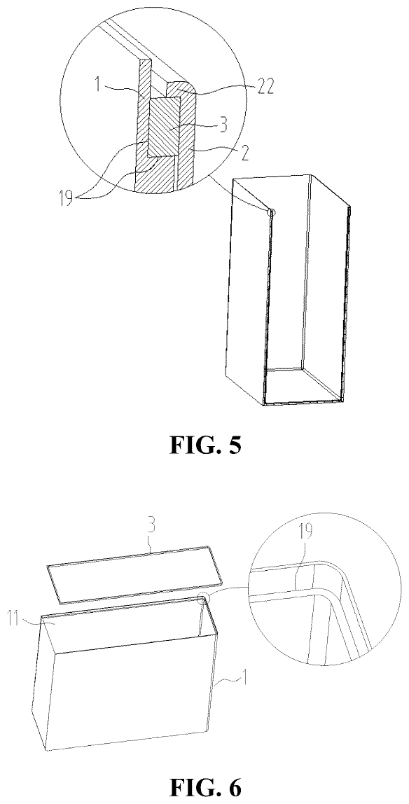

As shown in FIG. 5, an edge of the second opening 21 of the inner liner shell 2 is bent outwards to form a bent portion 22. The bent portion 22 and the peripheral wall of the inner liner shell 2 form a right angle, and a bottom of the bent portion 22 forms stepped engagement with an upper side of the connection ring 3, so that the welding fixation between the inner liner shell 2 and the connection ring 3 is firmer, and the embedding firmness of the inner liner shell 2 inside the outer shell 1 is improved.

Further, the bent portion 22 can also be formed by circumferential protrusion of a peripheral wall of the inner liner shell 2 that is close to the second opening 21, that is, the bent portion 22 protrudes out of the peripheral wall of the inner liner shell 2 as a circumferential protrusion, as shown in FIG. 8.

Certainly, when the inner wall of the outer shell is provided with the step surface 19, the connection ring 3 can also be omitted, and the bent portion 22 is directly snapped into the step surface 19 and fixedly connected by welding.

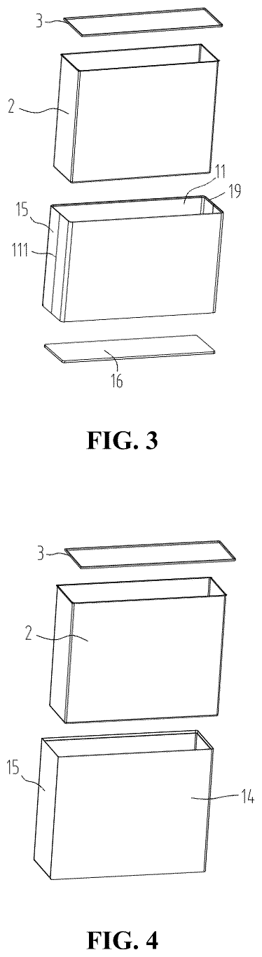

Further, the outer shell 1 includes a first side plate 12, a second side plate 13, a third side plate 14, a fourth side plate 15, and a bottom plate 16. The first side plate 12, the second side plate 13, and the third side plate 14 are integrally formed and can be formed by bending a plate body end to end, and the second side plate 13 is integrally formed between the first side plate 12 and the third side plate 14, as shown in FIG. 3. The fourth side plate 15 and the bottom plate 16 are fixedly connected to each other by welding. The fourth side plate 15 and the bottom plate 16 are formed by an integrated plate body, that is, an L-shaped plate. An opening of the outer shell 1 that corresponds to the fourth side plate 15 is a fourth opening 18. The L-shaped plate is welded to a case enclosed by three side plates, that is, the fourth side plate 15 is welded to the fourth opening 18, and the bottom plate 16 is welded to a third opening 17. This facilitates the embedding of the inner liner shell 2. Furthermore, during processing and molding of the outer shell 1, compared with an integrated molding processing manner, the combined welding manner in the present disclosure makes the outer shell 1 less likely to deform.

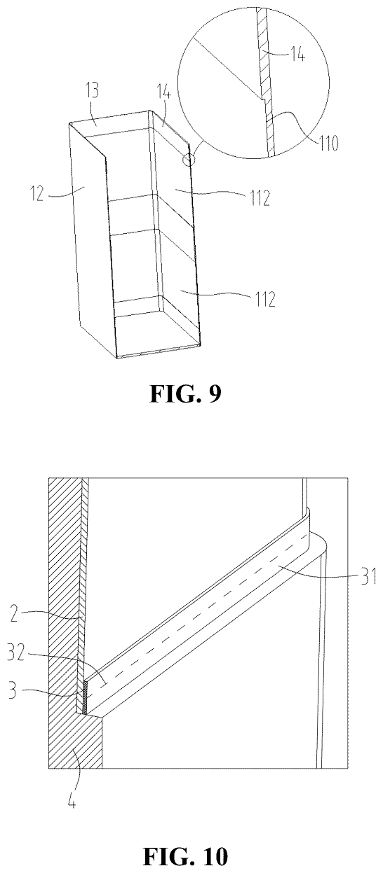

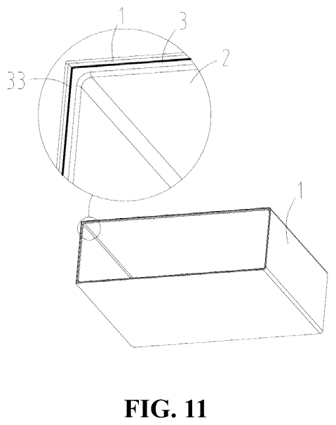

Grooves 110 are formed in an inner wall of the first side plate 12, an inner wall of the second side plate 13, an inner wall of the third side plate 14, and an inner wall of the fourth side plate 15. The four grooves 110 corresponding to the four side plates that are enclosed are enclosed to form an annular groove 110, as shown in FIG. 9. In this embodiment, each side plate has at least one groove 110, and a plurality of grooves 110 on each side plate are distributed in parallel in a height direction of the side plate, so that after the four side plates are enclosed, a plurality of parallel annular grooves 110 are formed on side walls of the outer shell 1. After the inner liner shell 2 is embedded into the outer shell 1, an outer wall of the inner liner shell 2 abuts against an inner side wall of the outer shell 1, and the outer wall of the inner liner shell 2 covers openings of the grooves 110, so that the outer wall of the inner liner shell 2 and the grooves 110 are enclosed to form a constant-temperature channel 112. The constant-temperature channel 112 can be filled with a heating source or cooling source, such as heating liquid or cooling liquid, to implement cooling or heating on or a constant temperature of an entire case. A joint is arranged on a peripheral wall of the outer shell 1. The joint is communicated to the constant-temperature channel 112. It is very convenient to perform liquid injection or replacement on the constant-temperature channel 112 through the joint.

A manufacturing and molding process for an insulation case structure for a battery in this embodiment includes the following steps:
Step I: Prepare a first plate body and a second plate body, where both the first plate body and the second plate body are formed by cutting a slab. A groove 110 is formed in a surface of the first plate body, and the groove 110 penetrates through two opposite ends of the plate body. In this way, after the first plate body is enclosed, an annular constant-temperature channel 112 can be formed. In this embodiment, a forming manner for the groove 110 is a conventional technology, such as using a slotting machine to perform slotting processing on the first plate body.
Step II: Bend the first plate body to form a C-shaped plate with a bending angle that is a right angle, bend the second plate body to form an L-shaped plate, and weld the L-shaped plate and the C-shaped plate to form an outer shell 1 with a first opening 11, where the outer shell 1 is the outer shell 1 in the first embodiment, namely, the first side plate 12, the second side plate 13, and the third side plate 14 are enclosed to form the C-shaped plate, and the fourth side plate 15 and the bottom plate 16 form the L-shaped plate.

This embodiment requires an intermediate layer. In this case, an intermediate layer is welded to an inner wall of each side plate. The intermediate layer can be made of a metal material or an insulation material.

In this embodiment, the intermediate layer abuts against and is connected to a surface of the first plate body by welding to cover the groove 110, and then the plate body is bent.
Step III: Prepare a slab, bend and weld the slab to form a square tubular member, longitudinally cut an open end of the tubular member, and form a square connection ring 3 after cutting.
Step IV: Prepare an inner liner shell 2. In this embodiment, a material of the inner liner shell 2 is plastic, which is made by injection molding or blow molding. The connection ring 3 is sleeved on a second opening 21 of the inner liner shell 2. One side of the connection ring 3 abuts against a peripheral wall of the inner liner shell 2 and another side of the connection ring 3 is used as a welding operation surface 31. In this process, a fixture 4 can be used. In this embodiment, the fixture 4 is of a square block structure, and the inner liner shell 2 is sleeved on the fixture 4 in an upside-down manner. An outer wall of the fixture 4 supports and positions the inner liner shell 2. After a side surface of the connection ring 3 abuts against the inner liner shell 2, the connection ring 3 can flatly abut against an outer wall of the inner liner shell 2 by pressing the welding operation surface 31 of the connection ring 3, and the connection ring 3 and the second opening 21 of the inner liner shell 2 can be aligned while pressing against the fixture 4, to limit the connection ring 3 and the inner liner shell 2 and avoid the connection ring 3 and the inner liner shell 2 from moving in a welding process.
Step V: Perform penetration welding with dense connection points on the welding operation surface 31 to fixedly connect the connection ring 3 with the inner liner shell 2, where a spot-welding trajectory 32 is distributed in a circumferential direction of the connection ring 3 and is located in a middle position of the welding operation surface 31.
Step VI: Embed the inner liner shell 2 welded with the connection ring 3 into the outer shell 1, to cause the welding operation surface 31 of the connection ring 3 to abut against an inner wall of the outer shell 1.
Step VII: After the welding operation surface 31 abuts against the inner wall of the outer shell 1, form an annular junction line between a top of the welding operation surface 31 and the inner wall of the outer shell 1 in the circumferential direction of the connection ring 3, and perform dense spot welding along the junction line 33 to fixedly connect the connection ring 3 with the outer shell 1. In this embodiment, the spot welding here employs dense and continuous laser spot welding.

### Second Embodiment

Basic structures of this embodiment are the same as those in the first embodiment, but a difference is that as shown in FIG. 4, the first side plate 12, the second side plate 13, the third side plate 14, and the fourth side plate 15 are formed by bending and connecting a plate body end to end to form a case that has openings in two ends. A joint line 111 is formed at an end-to-end connection position. The joint line 111 is located on one side plate and is connected by welding. This side plate is a wider side plate, and a first opening 11 and a third opening 17 are respectively formed at the openings in the two ends of the case. The bottom plate 16 is welded at the third opening 17.

A manufacturing and molding process for an insulation case structure for a battery in this embodiment includes the following steps:
Step I: Prepare a first plate body and a second plate body, where both the first plate body and the second plate body are formed by cutting a slab. A groove 110 is formed in a surface of the first plate body, and the groove 110 penetrates through two opposite ends of the plate body. In this way, after the first plate body is enclosed, an annular constant-temperature channel 112 can be formed. In this embodiment, a forming manner for the groove 110 is a conventional technology, such as using a slotting machine to perform slotting processing on the first plate body.
Step II: Bend the first plate body to form a C-shaped plate with a bending angle that is a right angle, dock two open ends of the C-shaped plate after relatively right-angle bending is performed on the two open ends, form a joint line 111 at an abutment position, where the joint line 111 is fixedly connected by welding; the second plate body is welded to a bottom of the first plate body as a bottom plate 16, thus forming an outer shell 1 with a first opening 11. The outer shell 1 is the outer shell 1 in the second embodiment.

In this embodiment, an intermediate layer can or cannot be provided. If the intermediate layer is provided, refer to the step in the first embodiment.
Step III: Prepare a slab, bend and weld the slab to form a square tubular member, longitudinally cut an open end of the tubular member, and form a square connection ring 3 after cutting.
Step IV: Prepare an inner liner shell 2. In this embodiment, a material of the inner liner shell 2 is plastic, which is made by injection molding or blow molding. The connection ring 3 is sleeved on a second opening 21 of the inner liner shell 2. One side of the connection ring 3 abuts against a peripheral wall of the inner liner shell 2 and another side of the connection ring 3 is used as a welding operation surface 31. In this process, a fixture 4 can be used. In this embodiment, the fixture 4 is of a square block structure, and the inner liner shell 2 is sleeved on the fixture 4 in an upside-down manner. An outer wall of the fixture 4 supports and positions the inner liner shell 2. After a side surface of the connection ring 3 abuts against the inner liner shell 2, the connection ring 3 can flatly abut against an outer wall of the inner liner shell 2 by pressing the welding operation surface 31 of the connection ring 3, and the connection ring 3 and the second opening 21 of the inner liner shell 2 can be aligned while pressing against the fixture 4, to limit the connection ring 3 and the inner liner shell 2 and avoid the connection ring 3 and the inner liner shell 2 from moving in a welding process.
Step V: Perform penetration welding with dense connection points on the welding operation surface 31 to fixedly connect the connection ring 3 with the inner liner shell 2, where a spot-welding trajectory 32 is distributed in a circumferential direction of the connection ring 3 and is located in a middle position of the welding operation surface 31.
Step VI: Embed the inner liner shell 2 welded with the connection ring 3 into the outer shell 1, to cause the welding operation surface 31 of the connection ring 3 to abut against an inner wall of the outer shell 1.
Step VII: After the welding operation surface 31 abuts against the inner wall of the outer shell 1, form an annular junction line between a top of the welding operation surface 31 and the inner wall of the outer shell 1 in the circumferential direction of the connection ring 3, and perform dense spot welding along the junction line 33 to fixedly connect the connection ring 3 with the outer shell 1. In this embodiment, the spot welding here employs dense and continuous laser spot welding.

### Third Embodiment

Basic structures of this embodiment are the same as those in the first embodiment, but a difference is that the outer shell 1 is of a box structure with an opening, which is formed by enclosing a first side plate 12, a second side plate 13, a third side plate 14, a fourth side plate 15, and a bottom plate 16. An opening in an upper end is a first opening 11. That is, the first side plate 12, the second side plate 13, the third side plate 14, the fourth side plate 15, and the bottom plate 16 are integrated. The first side plate 12, the second side plate 13, the third side plate 14, the fourth side plate 15, and the bottom plate 16 are formed by a plate body, such as punch forming, and their structures are similarly shown in FIG. 2.

A manufacturing and molding process for an insulation case structure for a battery in the present disclosure includes the following steps:
Step I: Prepare a first plate body and a second plate body, where both the first plate body and the second plate body are formed by cutting a slab.
Step II: Directly stretch the first plate body to form the outer shell 1 with the first opening 11 in a top. That is, the outer shell 1 is formed by directly stretching the plate body. The outer shell 1 is the outer shell 1 in the third embodiment.
Step III: Prepare a slab, bend and weld the slab to form a square tubular member, longitudinally cut an open end of the tubular member, and form a square connection ring 3 after cutting.
Step IV: Prepare an inner liner shell 2. In this embodiment, a material of the inner liner shell 2 is plastic, which is made by injection molding or blow molding. The connection ring 3 is sleeved on a second opening 21 of the inner liner shell 2. One side of the connection ring 3 abuts against a peripheral wall of the inner liner shell 2 and another side of the connection ring 3 is used as a welding operation surface 31. In this process, a fixture 4 can be used. In this embodiment, the fixture 4 is of a square block structure, and the inner liner shell 2 is sleeved on the fixture 4 in an upside-down manner. An outer wall of the fixture 4 supports and positions the inner liner shell 2. After a side surface of the connection ring 3 abuts against the inner liner shell 2, the connection ring 3 can flatly abut against an outer wall of the inner liner shell 2 by pressing the welding operation surface 31 of the connection ring 3, and the connection ring 3 and the second opening 21 the inner liner shell 2 can be aligned while pressing against the fixture 4, to limit the connection ring 3 and the inner liner shell 2 and avoid the connection ring 3 and the inner liner shell 2 from moving in a welding process.
Step V: Perform penetration welding with dense connection points on the welding operation surface 31 to fixedly connect the connection ring 3 with the inner liner shell 2, where a spot-welding trajectory 32 is distributed in a circumferential direction of the connection ring 3 and is located in a middle position of the welding operation surface 31.
Step VI: Embed the inner liner shell 2 welded with the connection ring 3 into the outer shell 1, to cause the welding operation surface 31 of the connection ring 3 to abut against an inner wall of the outer shell 1.
Step VII: After the welding operation surface 31 abuts against the inner wall of the outer shell 1, form an annular junction line between a top of the welding operation surface 31 and the inner wall of the outer shell 1 in the circumferential direction of the connection ring 3, and perform dense spot welding along the junction line 33 to fixedly connect the connection ring 3 with the outer shell 1. In this embodiment, the spot welding here employs dense and continuous laser spot welding.

The present disclosure is not limited to the above optimal embodiments. Anyone can derive various other forms of products from the inspiration of the present disclosure, but regardless of any changes in its shape or structure, any technical solution that is the same or similar to the present application falls within the protection scope of the present disclosure.

What is claimed is:

1. An insulation case structure for a battery, comprising:
an outer shell, wherein a first opening is formed in one side of the outer shell;
an inner liner shell made of an insulation material, wherein the inner liner shell is embedded into the outer shell through the first opening; a second opening that is arranged in the same direction as the first opening is formed in one end of the inner liner shell; and
a connection ring, wherein the connection ring is arranged between a periphery of the second opening and an inner wall of the outer shell in a surrounding manner, and
wherein the connection ring and a peripheral wall of the inner liner shell are fixed together by welding; and the connection ring and the inner wall of the outer shell are fixedly connected to each other.

2. The insulation case structure for the battery according to claim 1, wherein the outer shell is of a box structure that is formed by enclosing a first side plate, a second side plate, a third side plate, a fourth side plate, and a bottom plate and has an opening; and the opening is formed as the first opening.

3. The insulation case structure for the battery according to claim 2, wherein the first side plate, the second side plate, and the third side plate are formed by bending a plate body end to end; and
the fourth side plate and the bottom plate are fixedly connected to each other by welding, or the fourth side plate and the bottom plate are integrally arranged.

4. The insulation case structure for the battery according to claim 2, wherein the first side plate, the second side plate, the third side plate, and the fourth side plate are of a box structure that is formed by bending and connecting a plate body end to end and has openings in two ends; a joint line is located on a narrow-surface side plate and is connected by welding; the first opening and a third opening are respectively formed in the openings in the two ends of the outer shell; and the bottom plate is welded at the third opening.

5. The insulation case structure for the battery according to claim 2, wherein grooves are formed in an inner wall of the first side plate, an inner wall of the second side plate, an inner wall of the third side plate, and an inner wall of the fourth side plate to form a constant-temperature channel between the outer shell and the inner liner shell.

6. The insulation case structure for the battery according to claim 1, wherein a cross section of the connection ring is square; one side surface of the connection ring abuts against and is welded with the inner liner shell; and another opposite side surface of the connection ring abuts against and is welded with a side inner wall of the outer shell.

7. The insulation case structure for the battery according to claim 6, wherein a step surface is arranged on the inner wall of the outer shell; a bottom surface and a side surface, which faces the side inner wall of the outer shell, of the connection ring are snapped into the step surface; the second opening of the inner liner shell is outwards bent to form a bent portion, or a peripheral wall of the inner liner shell that is close to the second opening circumferentially protrudes out to form the bent portion; and a top surface and a side surface, which faces the peripheral wall of the inner liner shell, of the connection ring are snapped into the bent portion.

8. The insulation case structure for the battery according to claim 4, wherein the inner liner shell is made of the insulation material, and the connection ring and the outer shell are made of the same metal material.
